(19) United States
(12) Patent Application Publication
(10) Pub. No.: US 2016/0032023 A1
(43) Pub. Date: Feb. 4, 2016

(54) CONTINUOUS EMULSION POLYMERIZATION PROCESS AND INITIATION SYSTEM

(71) Applicant: CELANESE EMULSIONS GMBH, SULZBACH (TAUNUS) (DE)

(72) Inventor: David ADAMS, Bad Soden (DE)

(21) Appl. No.: 14/813,526

(22) Filed: Jul. 30, 2015

Related U.S. Application Data
(60) Provisional application No. 62/031,476, filed on Jul. 31, 2014.

(51) Int. Cl. C08F 2/01

(52) U.S. Cl. CPC C08F 2/01

(57) ABSTRACT

In a continuous emulsion polymerization process, at least one monomer, an aqueous phase, and at least two different redox initiators are added to a continuous polymerization reactor comprising a first zone and a second zone. At least one redox initiator is added to the first zone and at least one redox initiator is added to the second zone.

### FIELD

The invention relates to continuous emulsion polymerization processes and polymerization initiation systems for continuous emulsion polymerization reactors, more specifically, multiple initiator systems for continuous emulsion polymerization reactors with staged reaction zones.

### BACKGROUND

Emulsion polymerization is a complex process in which radical addition polymerization proceeds in a heterogeneous system. This process often involves emulsification of a relatively hydrophobic monomer in water by an emulsifier, followed by the initiation reaction with a free radical initiator, for example. At the end of the polymerization, a milky fluid called “latex”, “synthetic latex” or “polymer dispersion” is obtained. Latex is a colloidal dispersion of polymer particles in an aqueous medium. In general, latexes contain 40-60% polymer solids and comprise a large population of polymer particles dispersed in the continuous aqueous phase (about 10¹⁵ particles per mL of latex, for example). The particles can be within the size range 10 nm to 1000 nm in diameter, for example, and are generally spherical. A typical particle can be composed of 1-10000 macromolecules, with each macromolecule containing about 100-10⁶ monomer units.

Emulsion polymerization can take place in various reactors, including both batch and continuous reactors. A continuously stirred tank reactor (“CSTR”) is one kind of continuous reactor. Another type of continuous reactor is a continuous tubular emulsion polymerization reactor comprising a first section with a closed circulation loop, a driving means, such as a circulation pump, for circulating a reactor charge within the circulation loop, and a discharge connected to a secondary line section. Water phase, or another suitable carrier, monomers, polymerization initiators and optionally stabilizers are continuously fed to the loop and circulated. Polymer dispersion is continuously drawn off at the same rate at which the water phase, monomers and initiators are fed into the reactor.

Such types of reactors are discussed in WO 2007/031478, incorporated herein by reference. This publication describes that such reactors are particularly suitable for the production of polymers derived from vinyl and/or acrylic monomers, used for instance in paints or adhesives.

EP 0 417 893 A1 discloses an emulsion polymerization process in a loop reactor. Water, monomers, and stabilizers are continuously fed to the loop and circulated and emulsion polymer is continuously drawn off. The monomers may be added neat or in a pre-emulsion. An oxidant is added to the flow containing monomer. In order to prevent premature polymerization, a reductant is carried by a separate aqueous flow and fed into the reactor at a different point.

However, the productivity of continuous reactors for emulsion polymerization is often limited by the inability to achieve complete, or near complete, monomer conversion within the desired residence time of materials passing though the reactor. The shortfall in monomer conversion can in some cases be remedied by increasing the mean residence time of material flow though the reactor (i.e., decreasing the production rate), but this is a disadvantage for a commercial process.

Consequently, the need exists for a continuous emulsion polymerization process capable of achieving complete, or nearly complete, monomer conversion at shorter residence times.

### SUMMARY

The present invention relates to continuous emulsion polymerization in a staged polymerization reactor initiated by multiple polymerization initiators, the initiators being introduced at different stages of the reactor.

In one embodiment, the invention involves a continuous emulsion polymerization process comprising adding at least one monomer, an aqueous phase, and at least two different redox initiators to a continuous tubular reactor comprising (1) a circulating loop section and (2) a secondary line section having one end connected to a discharge opening of the loop section and a polymer outlet at its other end; and polymerizing the at least one monomer. The at least two different redox initiators may be added to the tubular reactor at different locations, such as in the circulating loop section and/or in the secondary line section. In other embodiments, the oxidizing agent from at least one of the at least two different redox initiators is added directly to the monomer before adding to the tubular reactor. Or the reducing agent from at least one of the at least two different redox initiators is added to the aqueous phase before adding to the tubular reactor. In certain embodiments, at least one of the at least two different redox initiators is water soluble and at least one of the at least two different redox initiators is oil soluble.

The oxidizing agents for the at least two different redox initiators might be chosen from the group consisting of tert-butyl hydroperoxide and t-butyl peroxy 3,5,5-trimethylhexanoate, for example. The reducing agents for the at least two different redox initiators might be chosen from the group consisting of sodium metabisulphite and sodium formaldehyde sulphoxylate, for example.

In certain embodiments, the tubular reactor includes two or more inlets through which the at least two redox initiators can be supplied to the tubular reactor at either the circulating loop section or the secondary line section. The tubular reactor might also comprise a pump for continuously circulating the at least one monomer within the circulating loop section under conditions to effect polymerization thereof.

In another embodiment, the invention involves a continuous emulsion polymerization process comprising adding at least one monomer, an aqueous phase, and at least two different initiators to a continuous emulsion polymerization reactor comprising at least two reaction stages; and polymerizing the at least one monomer; wherein the at least two different initiators are introduced at different stages of the reactor. In certain embodiments, the initiators are redox initiators.

### BRIEF DESCRIPTION OF THE DRAWINGS

The invention is described in detail below with reference to the appended drawings, in which:

FIG. 1 is a diagram of a continuous emulsion polymerization process according to one embodiment of the present invention.

### DETAILED DESCRIPTION

Emulsion polymerization reactions can be initiated by free radicals to give a dispersion of high-molecular weight polymer particles suspended in a medium in which the polymer is usually insoluble, for example water. A water soluble initiator is required for the process of emulsion polymerization to take place. The initiator can take several forms. For example, the initiator can be a material that generates free radicals upon thermal disassociation. The initiator can also originate from a pair of materials that when combined become active in producing free radicals. This is known as a reduction-oxidation or redox initiator. Redox initiator pairs comprise both an oxidizing agent or oxidant and a reducing agent or reductant. Polymerization reactions are often conducted with a single pair of redox components to provide a source of initiating free radicals.

Applicants have surprisingly discovered, through experimentation, that improvement in monomer conversion can be achieved in a continuous emulsion polymerization process by using multiple redox initiators which may be added at various reaction stages. This allows for the possibility of significantly higher rates of production. In some embodiments, the process uses both water soluble and oil soluble redox initiators.

With respect to oxidizing agents, a water soluble oxidizing agent can be one having a water solubility of 2% or greater by weight, e.g., 2%, greater than 3%, greater than 5%, greater than 7%, by weight when measured at 20° C. and at atmospheric pressure in demineralized water. Similarly an oil soluble oxidizing agent can be one having a water solubility of less than 2% by weight, e.g., less than 1%, less than 0.5%, less than 0.1%, by weight when measured at 20° C. and at atmospheric pressure in demineralized water. Water soluble reducers are reducers having a water solubility of greater than 1% by weight, e.g., greater than 2%, greater than 3%, greater than 5%, by weight when measured at 20° C. and at atmospheric pressure in demineralized water. Oil soluble reducers are reducers having a higher oil solubility than sodium metabisulphate, often characterized in that they will have at least one carbon atom present.

The present invention therefore relates to a continuous emulsion polymerization process in a continuous reactor with multiple reaction stages. One example of such a continuous reactor comprises a series of CSTR reactors with each CSTR constituting a reaction stage. Another example is a tubular reactor comprising one or more circulation loops connected to a secondary line section. The tubular reactor can contain one or more inlets for raw material, one or more outlets, and a circulation pump for circulating a reactor charge within the circulation loop. As discussed, the polymerization reaction is initiated by multiple redox initiators. The multiple redox initiators can differ in composition. This means that although either the oxidizing agent or reducing agent may be the same between sets of pairs, the combination of oxidizing and reducing agents together as a pair are different between sets of pairs. In some embodiments, the continuous emulsion polymerization process can have staged reaction zones, for example in the circulating loop section and the secondary line section. Different redox initiators might be used in different stages or reaction zones.

### Continuous Emulsion Polymerization Reactor

The present invention is directed to a continuous emulsion polymerization process utilizing multiple redox initiators in continuous reactor having reaction stages, such as a tubular reactor. A tubular reactor can comprise a circulating loop section and a secondary line section having one end connected to a discharge opening of the circulating loop section and a polymer outlet at its other end. In operation, a reactor charge comprising fresh monomer and water phase is continuously supplied to the loop section and is circulated within the loop section by means of a pump. The reactor charge circulating within the loop section is maintained under polymerization conditions and a polymerized charge is continuously discharged from the loop section into the secondary line section at a rate substantially less than the rate of circulation of the reactor charge within the loop section but substantially the same as the rate at which the reactor charge is supplied to the loop section. The discharge rate and the circulation rate can be balanced to achieve low residual monomer content. Preferably the secondary line section has a volume of less than twice the volume of the closed loop section. Optionally, the first loop section and/or the secondary line section or a substantial portion thereof is coiled.

The secondary line section can, for example, be provided with at least two separate cooling jackets in serial arrangement. This allows for temperature adjustment and optimization of the different stages of polymerization as the reactor charge passes through the secondary line section. In this way, the first part of the secondary line section can be cooled to a lesser extent than a subsequent part of the secondary line section. The first part can for instance be cooled to a relatively high temperature of 70° C. or higher, e.g., 70° C., 90° C. or higher, 1000 or higher, for example, to maximize polymerization, whereas the subsequent part can be cooled to a greater extent, e.g., to 55° C. or less, 50° C. or less, 40° C. or less, so that the finished polymer emulsion is discharged to a storage tank at a reasonably low temperature.

Optionally, the secondary line section may have a diameter which is larger than the diameter of the line forming the closed loop section. For example the secondary line section may have a diameter which is 1.2 times larger, 1.5 times larger, 2 times larger, 5 times larger, than the diameter of the line forming the closed loop section. With a larger diameter, the reactor charge will move along the secondary line section at a relatively slower speed. In another possible embodiment, the diameter of the secondary line section can be smaller than the diameter of the line forming the circulating loop section, which will increase the shear rate in the former. For example, the diameter of the line forming the circulating loop section can be 1.2 times larger, 1.5 times larger, 2 times larger, 5 times larger, than the diameter of the secondary line section. In a preferred embodiment, the diameter of the secondary line section is the same as the diameter of the circulating loop section. Even with the same diameter pipe, the flow rates of the fluid in the two sections will differ as a consequence of forced circulation in the loop section due to the pump, while the flow velocity in the secondary stage is determined only by the sum of the feed rates. For example, in one embodiment, the speed of the reactor charge in the loop section is on the order of 3.5 m/s, while the speed of the reactor charge in the secondary line section is on the order of 0.2 m/s. The speed of the reactor charge in the loop section and in the secondary line section can vary. For example, the speed of the reactor charge can be on the order of 0.1 m/s or greater, e.g., 0.5 m/s or greater, 1 m/s or greater, 3 m/s or greater, 5 m/s or greater. Similarly, as another example, the speed of the reactor charge in the secondary line section can be on the order of 0.05 m/s or greater, 0.1 m/s or greater, 0.5 m/s or greater, 1 m/s or greater.

The discharge rate and the circulation rate in the circulating loop section of the tubular reactor can be adjusted to obtain a desired monomer content. For example, in certain embodiments, the discharge rate and the circulation rate in the circulating loop section of the tubular reactor can be balanced such as to result in a monomer content in the loop of less than 12 wt. %, e.g., less than 10 wt. %, less than 7 wt. %, less than 5 wt. %.

### Polymerization of Monomers

The polymerization of monomers can take place in aqueous suspension and preferably the raw materials are provided by separate feed streams. These streams introduce monomer and optionally an aqueous solution of stabilizer known as the water phase or, e.g., a pre-emulsion of monomer and water with stabilizer and an aqueous stabilizer solution in a separate small stream. At the start of the reaction the reactor is filled with water phase made up in a solution tank. Other additions are also possible, particularly finished emulsion polymer (of the same or a different composition) from a previous run, optionally diluted to any concentration.

Some typical commercial monomers suitable for use in the present polymerization process include, e.g., compounds containing at least one double bond and an aromatic ring such as styrene; heterocyclic vinyl compounds such as 2-vinyl pyridine; vinyl acetate, and other vinyl esters including e.g. VEOVA™ 9 and VEOVA 10, vinyl propionate and vinyl laurate; alkenes such as ethylene and higher homologues, compounds having more than one double bond such as butadiene and higher homologues; acrylic and methacrylic acid together with their esters of branched or linear alcohols, e.g., methyl acrylate, ethyl acrylate, butyl acrylate, 2-ethyl hexyl acrylate or methyl methacrylate, n-butyl methacrylate, t-butyl methacrylate and the like; or vinyl halides such as vinyl chloride and methyl vinyl chloride. Additionally smaller amounts of so called functional monomers may be added to efficiently enhance or attribute a particular technical quality to the product. Such monomers are well known in the art and may comprise for example mono or dicarboxylic acids such as acrylic or methacrylic acid, itaconic acid, or maleic acid. Monomers for internal and post application cross-linking commonly used are diallyl phthalate, divinyl adipate, vinyl trimethyl silane, N-methylol acrylamide, methylacrylamidoglycolate and glycidyl methacrylate. For further reactions, monomers having hydroxyl or CO groups such as hydroxyl alkyl methacrylates or diacetoneacrylamide may be added.

The addition reaction is initiated by free radicals to give a dispersion of high molecular weight polymer particles usually of 50 to 3000 nm diameter, e.g., 100 to 2000 nm, 100 to 1000 nm in diameter, 200 to 600 nm in diameter, suspended in a medium in which the polymer is insoluble, usually water.

Agitation in the reactor can be provided by virtue of an in-line circulation pump, for example. In some embodiments, agitation can be provided using a mechanical agitator, such as in the case of a CSTR. Agitation can also be provided by monomer and material flow through the reactor tube. In some embodiments, shortly after the feed streams start to flow, the monomers begin to react and heat is generated. The temperature can be stabilized by cooling means, usually by controlled circulation of a cooling fluid (e.g. water) through a cooling jacket. In some embodiments, the product flows to a cooling tank, where, if necessary, residual monomer can be further converted to polymer by adding more initiators to the polymer dispersion. After cooling, the emulsion polymer can be filtered to remove any oversize particles or gritty material in a strainer and transferred to a product storage tank.

Optionally, the polymerization process can be carried out under pressure, for instance under a pressure between 1 to 300 bar, but preferably between 5 to 100 bar, more preferably between 10 to 20 bar. Alternatively, the polymerization may be carried out at ambient pressure.

### Example of a Continuous Tubular Reactor

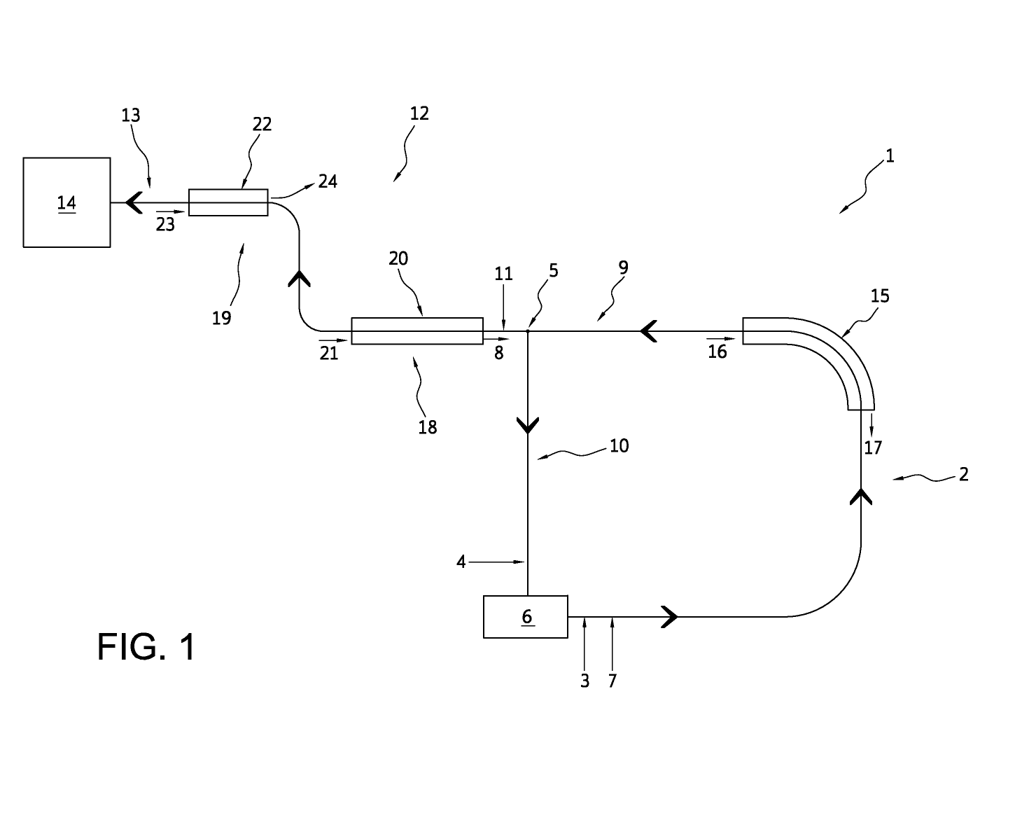

One example of a continuous emulsion polymerization reactor is shown in FIG. 1, in which the reactor 1 comprises a circulation loop 2 with a monomer inlet 3, a water phase inlet 4, an initiator inlet 7, and a discharge outlet 5. A circulation pump 6 driven by a motor (not shown) serves as a driving means for circulating a reactor charge within the circulation loop 2, to an upper section 9 of the circulation loop 2. The circulation loop 2, including the upper section 9, can optionally be coiled in full or in part (not shown). In the upper section 9, the reactor charge flows down and via line section 10 back to the circulation pump 6, where the main part of the reactor charge is re-circulated again, except for the part that is discharged via outlet 5. The discharged reactor charge can have a residual monomer content of about 3 to 10% by weight, e.g., 3 wt. %, 5 wt. %, 7 wt. %, 10 wt. %. To obtain a continuous polymerization process, the outlet of the circulation loop 2 is such that the outflow rate equals the inflow rate of the raw materials and is substantially less than the flow rate of the re-circulated material. For example, the flow rate of the outlet of the circulation loop can be less than 50%, e.g., less than 30%, less than 10%, less than 5%, less than 2%, of the flow rate of the flow rate of the circulation loop.

The reactor 1 further comprises a secondary line section 12 leading from the outlet 5 of the circulation loop 2. The secondary line section can be optionally coiled (not shown). An initiator feed line 11 for introducing additional initiator can be located at or near the beginning of the secondary line section. A discharge line 13 leads from the secondary line section 12 to a cooling tank 14. The volume of the secondary line section 12 is preferably about equal to the volume of the circulation loop 2.

All or part tube of the circulation loop 2 can be covered by a hollow cooling jacket 15, through which cooling water flows. The cooling jacket 15 is connected to a cooling water inlet 16 and a cooling water outlet 17.

The secondary line section 12 can also be cooled and may have a lower part 18 and a separately cooled upper part 19. To this end, the lower part 18 may be provided with a cooling jacket 20, connected to a water inlet 21 and a water outlet 22. Similarly, the upper part 19 may be provided with a separate cooling jacket 8, connected to another water inlet 23 and a water outlet 24. The lower part 18 of the secondary line section 12 is connected to the discharge outlet 5 of the circulation loop 2 and can be cooled to a lesser extent than the subsequently cooled upper part 19 of the secondary line section 12.

### Initiator System

The present invention uses two or more initiators in the continuous emulsion polymerization to effect a more complete conversion of monomer. The initiators can be redox initiators. In a preferred embodiment, the invention utilizes a water soluble redox initiator and an oil soluble (or particle soluble) redox initiator. The water soluble redox initiator might be used in a first or primary reaction zone, while the oil soluble redox initiator might be used in a second stage reaction zone, for example. In other preferred embodiments, the oxidizing agent and reducing agent from one or each redox initiator can be used in different stages. For example, the water soluble redox initiator and the oxidizing agent from the oil soluble redox pair can be added in the first or primary reaction zone, while the reducing agent from the oil soluble redox pair is added in the secondary stage reaction zone. In another example, the water soluble redox initiator and the reducing agent from the oil soluble redox pair can be added in the first or primary reaction zone, while the oxidizing agent from the oil soluble redox pair is added in the secondary stage reaction zone.

As discussed, a redox couple typically comprises a pair or couple comprising an oxidizing agent and a reducing agent. Exemplary oxidizing agents include the salts of peroxodisulphuric acid, t-butyl hydroperoxide, di-tert-amyl peroxide, tert-butyl peroxybenzoate, t-amyl hydroperoxide, tert-butyl peroxy-3,5,5-trimethylhexanoate, tert-butyl peroxide, cumyl hydroperoxide, and hydrogen peroxide itself. Exemplary water soluble reducers include sulfur compounds having a low oxidation state such as metal alkali sulfites, for example sodium sulfite; alkali metal hydrogen sulfites, for example sodium hydrogen sulfite; alkali metal bisulfites, for example sodium metabisulfite; alkali metal sulfides, for example sodium hydrogen sulfide; salts of polyvalent metals such as iron (II) sulfate iron (II) phosphate; enediols, such as dihydroxymaleic acid or ascorbic acid; and reducing saccharides such as sorbose, fructose and/or dihydroxyacetone. Other examples of water soluble reducers include sodium formaldehyde sulphoxylate, sodium dithionate and sodium sulfinic acid derivatives (e.g., Bruggolite FF6). As discussed, oil or particle soluble reducers are reducers having a higher oil or particle solubility than sodium metabisulphate. Reducers having greater oil or particle solubility than sodium metabisulfite sulfoxylate; metal salts of aliphatic sulfinic acids such as 2-hydroxy-2-sulfinatoacetic acid; and all other reducers capable of breaking the oxygen-oxygen bond in oxidants having at least one carbon atom.

To form the redox couple, any of the above examples of oxidizing agents can be paired with any of the above examples of reducing agents. For illustrative purposes, examples of such pairings are shown in Table 1.

TABLE 1

| | Oxidizing Agent: | | | | | | | | |
|---|---|---|---|---|---|---|---|---|---|
| | | | | | | tert-butyl peroxy- | | | |
| | peroxodisulphuric | t-butyl | di-tert-amyl | tert-butyl | t-amyl | 3,5,5- | | cumyl | hydrogen |
| | acid | hydroperoxide | peroxide | peroxybenzoate | hydroperoxide | trimethylhexanoate | tert-butyl peroxide | hydroperoxide | peroxide |
| Reducing | metal alkali | metal alkali | metal alkali | metal alkali | metal alkali | metal alkali sulfites | metal alkali | metal alkali | metal alkali sulfites |
| Agent: | sulfites (sodium | sulfites (sodium | sulfites (sodium | sulfites (sodium | sulfites (sodium | (sodium sulfite) | sulfites (sodium | sulfites (sodium | (sodium sulfite) |
| | sulfite) | sulfite) | sulfite) | sulfite) | sulfite) | | sulfite) | sulfite) | |
| | alkali metal | alkali metal | alkali metal | alkali metal | alkali metal | alkali metal | alkali metal | alkali metal | alkali metal hydrogen |
| | hydrogen sulfites | hydrogen sulfites | hydrogen sulfites | hydrogen sulfites | hydrogen sulfites | hydrogen sulfites | hydrogen sulfites | hydrogen sulfites | sulfites (sodium |
| | (sodium hydrogen | (sodium hydrogen | (sodium hydrogen | (sodium hydrogen | (sodium hydrogen | (sodium hydrogen | (sodium hydrogen | (sodium hydrogen | hydrogen sulfite) |
| | sulfite) | sulfite) | sulfite) | sulfite) | sulfite) | sulfite) | sulfite) | sulfite) | |
| | alkali metal | alkali metal | alkali metal | alkali metal | alkali metal | alkali metal | alkali metal | alkali metal | alkali metal bisulfites |
| | bisulfites (sodium | bisulfites (sodium | bisulfites (sodium | bisulfites (sodium | bisulfites (sodium | bisulfites (sodium | bisulfites (sodium | bisulfites (sodium | (sodium metabisulfite) |
| | metabisulfite) | metabisulfite) | metabisulfite) | metabisulfite) | metabisulfite) | metabisulfite) | metabisulfite) | metabisulfite) | |
| | alkali metal | alkali metal | alkali metal | alkali metal | alkali metal | alkali metal | alkali metal | alkali metal | alkali metal sulfides |
| | sulfides (sodium | sulfides (sodium | sulfides (sodium | sulfides (sodium | sulfides (sodium | sulfides (sodium | sulfides (sodium | sulfides (sodium | (sodium hydrogen |
| | hydrogen sulfide | hydrogen sulfide | hydrogen sulfide | hydrogen sulfide | hydrogen sulfide | hydrogen sulfide | hydrogen sulfide | hydrogen sulfide | sulfide |
| | salts of polyvalent | salts of polyvalent | salts of polyvalent | salts of polyvalent | salts of polyvalent | salts of polyvalent | salts of polyvalent | salts of polyvalent | salts of polyvalent |
| | metals (iron (II) | metals (iron (II) | metals (iron (II) | metals (iron (II) | metals (iron (II) | metals (iron (II) | metals (iron (II) | metals (iron (II) | metals (iron (II) sulfate |
| | sulfate iron (II) | sulfate iron (II) | sulfate iron (II) | sulfate iron (II) | sulfate iron (II) | sulfate iron (II) | sulfate iron (II) | sulfate iron (II) | iron (II) phosphate) |
| | phosphate) | phosphate) | phosphate) | phosphate) | phosphate) | phosphate) | phosphate) | phosphate) | |
| | Enediols | Enediols | Enediols | Enediols | Enediols | Enediols | Enediols | Enediols | Enediols |
| | (dihydroxymaleic | (dihydroxymaleic | (dihydroxymaleic | (dihydroxymaleic | (dihydroxymaleic | (dihydroxymaleic | (dihydroxymaleic | (dihydroxymaleic | (dihydroxymaleic acid |
| | acid or ascorbic | acid or ascorbic | acid or ascorbic | acid or ascorbic | acid or ascorbic | acid or ascorbic | acid or ascorbic | acid or ascorbic | or ascorbic acid) |
| | acid) | acid) | acid) | acid) | acid) | acid) | acid) | acid) | |
| | reducing | reducing | reducing | reducing | reducing | reducing | reducing | reducing saccharides | reducing saccharides |
| | saccharides | saccharides | saccharides | saccharides | saccharides | saccharides | saccharides | (sorbose, fructose | (sorbose, fructose |
| | (sorbose, fructose | (sorbose, fructose | (sorbose, fructose | (sorbose, fructose | (sorbose, fructose | (sorbose, fructose | (sorbose, fructose | and/or | and/or |
| | and/or | and/or | and/or | and/or | and/or | and/or | and/or | dihydroxyacetone) | dihydroxyacetone) |
| | dihydroxyacetone) | dihydroxyacetone) | dihydroxyacetone) | dihydroxyacetone) | dihydroxyacetone) | dihydroxyacetone) | dihydroxyacetone) | | |
| | sodium | sodium | sodium | sodium | sodium | sodium | sodium | sodium | sodium |
| | formaldehyde | formaldehyde | formaldehyde | formaldehyde | formaldehyde | formaldehyde | formaldehyde | formaldehyde | formaldehyde |
| | sulphoxylate | sulphoxylate | sulphoxylate | sulphoxylate | sulphoxylate | sulphoxylate | sulphoxylate | sulphoxylate | sulphoxylate |
| | sodium dithionate | sodium dithionate | sodium dithionate | sodium dithionate | sodium dithionate | sodium dithionate | sodium dithionate | sodium dithionate | sodium dithionate |
| | sodium sulfinic | sodium sulfinic | sodium sulfinic | sodium sulfinic | sodium sulfinic | sodium sulfinic | sodium sulfinic | sodium sulfinic | sodium sulfinic acid |
| | acid derivatives | acid derivatives | acid derivatives | acid derivatives | acid derivatives | acid derivatives | acid derivatives | acid derivatives | derivatives (e.g., |
| | (e.g., Bruggolite | (e.g., Bruggolite | (e.g., Bruggolite | (e.g., Bruggolite | (e.g., Bruggolite | (e.g., Bruggolite | (e.g., Bruggolite | (e.g., Bruggolite | Bruggolite FF6) |
| | FF6) | FF6) | FF6) | FF6) | FF6) | FF6) | FF6) | FF6) | |
| | alkali metal | alkali metal | alkali metal | alkali metal | alkali metal | alkali metal | alkali metal | alkali metal | alkali metal sulfides |
| | sulfides (sodium | sulfides (sodium | sulfides (sodium | sulfides (sodium | sulfides (sodium | sulfides (sodium | sulfides (sodium | sulfides (sodium | (sodium |
| | formaldehyde | formaldehyde | formaldehyde | formaldehyde | formaldehyde | formaldehyde | formaldehyde | formaldehyde | formaldehyde |
| | sulfoxylate) | sulfoxylate) | sulfoxylate) | sulfoxylate) | sulfoxylate) | sulfoxylate) | sulfoxylate) | sulfoxylate) | sulfoxylate) |
| | metal salts of | metal salts of | metal salts of | metal salts of | metal salts of | metal salts of | metal salts of | metal salts of | metal salts of aliphatic |
| | aliphatic sulfinic | aliphatic sulfinic | aliphatic sulfinic | aliphatic sulfinic | aliphatic sulfinic | aliphatic sulfinic | aliphatic sulfinic | aliphatic sulfinic | sulfinic acids (2- |
| | acids (2-hydroxy- | acids (2-hydroxy- | acids (2-hydroxy- | acids (2-hydroxy- | acids (2-hydroxy- | acids (2-hydroxy- | acids (2-hydroxy- | acids (2-hydroxy-2- | hydroxy-2- |
| | 2-sulfinatoacetic | 2-sulfinatoacetic | 2-sulfinatoacetic | 2-sulfinatoacetic | 2-sulfinatoacetic | 2-sulfinatoacetic | 2-sulfinatoacetic | sulfinatoacetic acid) | sulfinatoacetic acid) |
| | acid) | acid) | acid) | acid) | acid) | acid) | acid) | | |

Transition metals salts can potentially be used advantageously in trace quantities to act as a catalyst for the initiation.

One method of feeding a first redox initiator to the continuous emulsion reactor is to add the oxidant component directly to the monomer and dissolve the reductant in the aqueous phase. This simple format allows for only two feed streams for the addition of the first redox initiator. Alternatively, there can be separate feed streams for the first redox components, which can be preferred when adding oxidant to monomer directly is problematic. This, however, may increase complexity, since at least one additional container, supply lines, meter and pump are needed.

The second redox initiator can be added with the first redox initiator or separately. The second redox initiator can be also added in the same manner as the first redox initiator or in a different manner. For example, if the first redox initiator is added directly to the monomer and the aqueous phase, the second redox initiator might be added the same way or the second redox initiator might be added with separate feed streams. Additional redox initiators can also be added in the same or different manners.

In another embodiment, a first redox initiator is added in a first reaction stage and a second redox initiator is added in a second reaction stage. For example, in the continuous emulsion reactors described, the first redox initiator can be added in the loop stage and the second redox pair can be added to the secondary stage. Since in some embodiments, the secondary stage of the reactor is a zone of comparatively low shear (mixing), redox components can be added at different points to avoid the components coming into contact and self-destroying. For example, if one half of a redox initiator, such as a reducing agent, is added at the inlet of the secondary stage of the reactor, the oxidizing agent might be added at the first stage of the reactor. In some embodiments, both components of this redox initiator have oil-solubility. Without being bound by theory, the oil soluble oxidizing agent may lie dormant within the forming polymer particle until activated by the reducing agent.

Although in certain embodiments, one or more of the redox initiators might be added in a manner so as to form a pre-emulsion, the invention itself is not analogous to a pre-emulsion. For example, the present invention uses at least two different redox initiators. In addition, the resulting emulsion polymer formed from any of these redox initiators is not in pre-emulsion form. Also, the monomers can be fed neat. Further, an objective of the present invention is to improve monomer conversion as the product exits both the first and second stages of the reactor. In contrast, pre-emulsions are typically used to remove grit, etc. For the same reasons, the present invention also differs from the additional polymerization of residual monomer after cooling. Thus, in one embodiment of the present process, the first and second redox initiators are added to the reactor at different locations with the temperature of the reagents at the different locations being substantially the same, that is with the difference in temperature between the locations being less than 20° C., for example less than 15° C., such as less than 10° C., for example less than 5° C.

### Stabilizers

The continuous emulsion polymerization process can also involve stabilizers. Suitable stabilizers are anionic and non-ionic surfactants, polymerizable stabilizers and surfactants, hydroxyethyl and hydroxymethyl cellulose and derivatives thereof, polyvinyl alcohols, polyvinyl pyrolidones, and surface-active water-soluble polyurethanes.

### Examples

A formulation totaling 1000 parts consisting of vinyl acetate with parts oxidant as given in the tables below was metered through a fine sinter under 82 bar pressure and into which 19 wt. % of monomers of ethylene was dissolved. The monomer/oxidant solution was directed into the pressure side of the circulating loop of a continuous tubular emulsion polymerization reactor consisting of (1) a circulating loop section and (2) a secondary line section having one end connected to a discharge opening of the loop section and a polymer outlet at its other end.

A water phase consisting of a total of 2.8 wt % on product of a mixed low/medium viscosity 88% hydrolyzed polyvinyl alcohol together with an appropriate amount of pH modifier, iron sulphate and 0.24 wt % on product of SMBS representing a large molar excess over the quantities of oxidants in the overall formulation was prepared. A fixed amount of water was added to complete the water phase which was fed to the suction side of the circulation pump. The feed rates were selected such that the mean residence time of material within the loop section of the tubular reactor was 12 minutes and the target solids content was 57%. The reaction temperature was set to 90° C. and the reaction pressure was 82 bar. The shear generated close to the tube wall in the recirculation component was calculated to have been 677 S⁻¹ and that in the secondary line section 79 S⁻¹.

The redox initiators used in the examples include tert-Butyl hydroperoxide (tBHP-water and particle soluble oxidant), TRIGONOX C (tert-Butyl peroxybenzoate-water insoluble, particle soluble oxidant), sodium metabisulfate (SMBS—water soluble reducer), and sodium formaldehyde sulfoxylate (SFS—water soluble, particle soluble reducer).

The following Tables 2-11 detail the amount of oxidants and reductants (in grams per 1000 g of formulation) added to either the circulating loop or secondary line sections.

The resultant monomer conversions for vinyl acetate and ethylene were measured and are reported in Table 12.

TABLE 2

| | Loop | 2^{nd} Stage |
|---|---|---|
| Run 1 | (g per 1000 g of | (g per 1000 g of |
| (Comparative) | formulation) | formulation) |
| tBHP | 1.2 | 0 |
| Trig C | 0 | 0 |
| SMBS | 2.4 | 0 |
| SFS | 0 | 0 |

TABLE 3

| | Loop | 2^{nd} Stage |
|---|---|---|
| Run 2 | (g per 1000 g of | (g per 1000 g of |
| (Comparative) | formulation) | formulation) |
| tBHP | 1.2 | 0 |
| Trig C | 0 | 0 |
| SMBS | 2.4 | 0.4 |
| SFS | 0 | 0 |

TABLE 4

| | Loop | 2^{nd} Stage |
|---|---|---|
| Run 3 | (g per 1000 g of | (g per 1000 g of |
| (Comparative) | formulation) | formulation) |
| tBHP | 1.2 | 0 |
| Trig C | 0 | 0 |
| SMBS | 2.4 | 0 |
| SFS | 0 | 0.4 |

TABLE 5

| | Loop | 2^{nd} Stage |
|---|---|---|
| Run 4 | (g per 1000 g of | (g per 1000 g of |
| (Comparative) | formulation) | formulation) |
| tBHP | 1.0 | 0 |
| Trig C | 0.3 | 0 |
| SMBS | 2.4 | 0 |
| SFS | 0 | 0 |

TABLE 6

| | Loop | 2^{nd} Stage |
|---|---|---|
| | (g per 1000 g of | (g per 1000 g of |
| Run 5 | formulation) | formulation) |
| tBHP | 1.0 | 0 |
| Trig C | 0.3 | 0 |
| SMBS | 2.4 | 0.1 |
| SFS | 0 | 0.2 |

TABLE 7

| | Loop | 2^{nd} Stage |
|---|---|---|
| | (g per 1000 g of | (g per 1000 g of |
| Run 6 | formulation) | formulation) |
| tBHP | 1.0 | 0 |
| Trig C | 0.3 | 0 |
| SMBS | 2.4 | 0.4 |
| SFS | 0 | 0 |

TABLE 8

| | Loop | 2^{nd} Stage |
|---|---|---|
| | (g per 1000 g of | (g per 1000 g of |
| Run 7 | formulation) | formulation) |
| tBHP | 1.0 | 0 |
| Trig C | 0.3 | 0 |
| SMBS | 2.4 | 0 |
| SFS | 0 | 0.4 |

TABLE 9

| | Loop | 2^{nd} Stage |
|---|---|---|
| Run 8 | (g per 1000 g of | (g per 1000 g of |
| (Comparative) | formulation) | formulation) |
| tBHP | 0.5 | 0 |
| Trig C | 0.6 | 0 |
| SMBS | 2.4 | 0 |
| SFS | 0 | 0 |

TABLE 10

| | Loop | 2^{nd} Stage |
|---|---|---|
| | (g per 1000 g of | (g per 1000 g of |
| Run 9 | formulation) | formulation) |
| tBHP | 0.5 | 0 |
| Trig C | 0.6 | 0 |
| SMBS | 2.4 | 0 |
| SFS | 0 | 0.2 |

TABLE 11

| | Loop | 2^{nd} Stage |
|---|---|---|
| | (g per 1000 g of | (g per 1000 g of |
| Run 10 | formulation) | formulation) |
| tBHP | 0.5 | 0 |
| Trig C | 0.6 | 0 |
| SMBS | 2.4 | 0 |
| SFS | 0 | 0.4 |

TABLE 12
Resultant Monomer Conversions

| | Vinyl Acetate | Ethylene |
|---|---|---|
| Run # | Conversion | Conversion |
| Run 1 | 88.4 | 83.7 |
| Run 2 | 90.0 | 84.4 |
| Run 3 | 89.8 | 84.4 |
| Run 4 | 90.6 | 87.9 |
| Run 5 | 94.5 | 92.4 |
| Run 6 | 90.2 | 86.2 |
| Run 7 | 95.8 | 93.3 |
| Run 8 | 86.5 | 81.7 |
| Run 9 | 93.5 | 90.6 |
| Run 10 | 96.3 | 94.0 |

Runs 1 to 3 are comparative examples and show that when tBHP alone is added in the primary reactor (loop), no additional reaction can be induced by adding either SMBS or SFS to the onset of the second stage. Runs 4 to 7 show that when some Trig C in incorporated in the primary charge, an enhancement to the second stage reaction can be gained when SFS is added to the onset of the second stage. This effect is not seen when SMBS is similarly fed. Runs 8 to 10 show this effect is more pronounced when more Trig C is added to the primary charge. From the data, it is apparent that the monomer conversions are increased when a second initiator pair is included, particularly when the reductant from that pair is introduced into the secondary line section and also where the secondary initiator pair has oil or particle solubility.

While the illustrative embodiments of the disclosure have been described with particularity, it will be understood that various other modifications will be apparent to and can be readily made by those skilled in the art without departing from the spirit and scope of the disclosure. Accordingly, it is not intended that the scope of the claims appended hereto be limited to the examples and descriptions set forth herein but rather that the claims be construed as encompassing all the features of the patentable novelty which reside in the present disclosure, including all features which would be treated as equivalents thereof by those skilled in the art to which the disclosure pertains.

We claim:

1. A continuous emulsion polymerization process comprising:
adding at least one monomer, an aqueous phase, and at least two different redox initiators to a continuous tubular reactor comprising (1) a circulating loop section and (2) a secondary line section having one end connected to a discharge opening of the loop section and a polymer outlet at its other end; and
polymerizing the at least one monomer.

2. The process of claim 1, wherein each redox initiator comprises a reducing agent and an oxidizing agent.

3. The process of claim 1, wherein the at least two different redox initiators are added to the tubular reactor at different locations.

4. The process of claim 2, wherein at least one of the at least two different redox initiators is added to the circulating loop section of the tubular reactor.

5. The process of claim 4, wherein the reducing agent from at least one of the at least two different redox initiators is added to the secondary line section of the tubular reactor.

6. The process of claim 4, wherein oxidizing agent from at least one of the at least two different redox initiators is added to the secondary line section of the tubular reactor.

7. The process of claim 2, wherein at least one of the at least two different redox initiators is water soluble and at least one of the at least two different redox initiators is oil soluble.

8. The process of claim 7, wherein the water soluble initiator is added to the reactor upstream of where the oil soluble initiator is added.

9. The process of claim 7, wherein the oxidizing agent from the oil soluble redox initiator is added to the circulating loop section of the tubular reactor and the reducing agent from the oil soluble redox initiator is added to the secondary line section of the tubular reactor.

10. The process of claim 7, wherein the reducing agent from the oil soluble redox initiator is added to the circulating loop section of the tubular reactor and the oxidizing agent from the oil soluble redox initiator is added to the secondary line section of the tubular reactor.

11. The process of claim 2, wherein the oxidizing agent from at least one of the at least two different redox initiators is added directly to the monomer before adding to the tubular reactor.

12. The process of claim 11, wherein the reducing agent from at least one of the at least two different redox initiators is added to the aqueous phase before adding to the tubular reactor.

13. The process of claim 1, wherein the oxidizing agents for the at least two different redox initiators are chosen from the group consisting of tBHP and t-butyl peroxy 3,5,5-trimethylhexanoate and the reducing agents for the at least two different redox initiators are chosen from the group consisting of SMBS and SFS.

14. The process of claim 1, wherein the tubular reactor further comprises two or more inlets through which the at least two redox initiators can be supplied to the tubular reactor at either the circulating loop section or the secondary line section.

15. The process of claim 1, wherein the tubular reactor further comprises a pump for continuously circulating the at least one monomer within the circulating loop section under conditions to effect polymerization thereof.

16. The process of claim 5, wherein the at least one monomer and the aqueous phase are continuously fed to the reactor at substantially the same rate as the rate of discharge into the secondary line section.

17. The process of claim 1, wherein the secondary line section of the tubular reactor has a volume of less than twice the volume of the circulating loop section.

18. The process of claim 1, wherein the discharge rate and the circulation rate in the circulating loop section of the tubular reactor are balanced such as to result in a monomer content in the loop section of less than 12 wt. %.

19. The process of claim 1, wherein the mean residence time in the circulating loop section of the tubular reactor is 12 minutes or less.

20. A continuous emulsion polymerization process comprising:
adding at least one monomer, an aqueous phase, and at least two different redox initiators to a continuous polymerization reactor comprising a first zone and a second zone; and
polymerizing the at least one monomer;
wherein at least one redox initiator is added to the first zone and at least one redox initiator is added to the second zone.
